(19) United States
(12) Patent Application Publication
(10) Pub. No.: US 2014/0208258 A1
(43) Pub. Date: Jul. 24, 2014

(54) Predictive Input Using Custom Dictionaries

(71) Applicants: Jenny Yuen, Cambridge, MA (US); Luke St. Clair, Redmond, WA (US)

(72) Inventors: Jenny Yuen, Cambridge, MA (US); Luke St. Clair, Redmond, WA (US)

(21) Appl. No.: 13/746,988

(22) Filed: Jan. 22, 2013

(51) Int. Cl. G06F 3/048

(52) U.S. Cl. CPC G06F 3/048
USPC 715/780

(57) ABSTRACT

In one embodiment, a method includes detecting that a first user is entering a text input at an input region of a computing device, wherein the input region includes multiple subregions and each subregion is associated with at least one character of a plurality of characters. The method also includes determining, for each character as the first user enters the text input, a probability that the character is next in the text input. The method further includes determining a size of each subregion based on the determined probability of the character associated with the subregion.

### TECHNICAL FIELD

This disclosure generally relates to providing input to a computer system, and more particularly to adapting characteristics of the input device based on custom dictionaries.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, or gyroscope. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter is related to a method including detecting that a first user is entering a text input at an input region of a computing device, wherein the input region includes multiple subregions and each subregion is associated with at least one character of a plurality of characters, determining, for each character as the first user enters the text input, a probability that the character is next in the text input, and determining a size of each subregion based on the determined probability of the character associated with the subregion.

For example, in particular embodiments, the size of the keys of a virtual keyboard may be modified based on the likelihood that each will be input next by the user. For example, as the user types on the virtual keyboard, particular embodiments may enlarge or otherwise make easier to type the keys on the keyboard that the user is most likely to type next based. In this way, the user may have a higher likelihood of performing the correct input on the first attempt without having the correct it. In some embodiments, determining the likelihood of a character being input next by the user may be based on a user dictionary. The user dictionary may be automatically built according to the user's input history, and may be constructed based on the context of the input, such as what type of communication is being utilized (e.g. email vs. SMS message) and/or with whom the user is communicating (e.g., personal vs. business contact, and groups vs. individuals).

The disclosed subject matter is also related to one or more computer-readable non-transitory storage media embodying software that is operable when executed to: detect that a first user is entering a text input at an input region of the computing device, wherein the input region includes multiple subregions and each subregion is associated with at least one character of a plurality of characters, determine, for each character as the first user enters the text input, a probability that the character is next in the text input, and determine a size of each subregion based on the determined probability of the character associated with the subregion.

The disclosed subject matter is further related to a system including one or more processors and a memory coupled to the processors. The memory includes instructions executable by the processors. The processors are operable when executing the instructions to: detect that a first user is entering a text input at an input region of the computing device, wherein the input region includes multiple subregions and each subregion is associated with at least one character of a plurality of characters, determine, for each character as the first user enters the text input, a probability that the character is next in the text input, and determine a size of each subregion based on the determined probability of the character associated with the subregion.

### BRIEF DESCRIPTION OF THE DRAWINGS

FIG. 1 illustrates an example network environment associated with a social-networking system in accordance with particular embodiments of the present disclosure;

FIG. 2 illustrates an example social graph in accordance with particular embodiments of the present disclosure;

FIG. 3 illustrate an example personal computing device in accordance with particular embodiments of the present disclosure;

FIG. 4 illustrates an example system for creating customized dictionaries in accordance with particular embodiments of the present disclosure;

FIG. 5 illustrates an example illustrates an example method for creating customized dictionaries in accordance with particular embodiments of the present disclosure;

FIGS. 6A-6B illustrate example wireframes of the personal computing device of FIG. 3 according to the disclosed subject matter.

FIG. 7 illustrates an example method for adapting characteristics of the input region of the personal computing device of FIG. 3 in accordance with particular embodiments of the present disclosure; and

FIG. 8 illustrates an example computer system in accordance with particular embodiments of the present disclosure.

### DESCRIPTION OF EXAMPLE EMBODIMENTS

Computing devices can include one or more input devices to receive input from a user, including a keyboard, pointing device, microphone, camera, or other suitable input device. Some computing devices can allow a user to provide input on an electronic visual display, such as a touch screen. In this manner, a user can provide input by touching a certain portions of the electronic visual display corresponding to a desired input (e.g. a key of a virtual keyboard). However, users can touch an incorrect portion of the electronic visual display, which can result in an incorrect input being provided, and thus the user can be required to undo the incorrect input and perform the input again. Such input errors can occur, for example, when the user intends to touch a particular portion of the display, and the computing device recognizes a different portion of the display as being touched.

Accordingly, one aspect of the present disclosure includes one or more systems and/or methods for improved input devices that can reduce input errors by adapting characteristics of the input device to particular users. In particular embodiments, the size of the keys of a virtual keyboard may be modified based on the likelihood that each will be input next by the user. For example, as the user types on the virtual keyboard, particular embodiments may enlarge or otherwise make easier to type the keys on the keyboard that the user is most likely to type next based. In this way, the user may have a higher likelihood of performing the correct input on the first attempt without having the correct it. In some embodiments, determining the likelihood of a character being input next by the user may be based on a user dictionary. The user dictionary may be automatically built according to the user's input history, and may be constructed based on the context of the input, such as what type of communication is being utilized (e.g. email vs. SMS message) and/or with whom the user is communicating (e.g., personal vs. business contact, and groups vs. individuals).

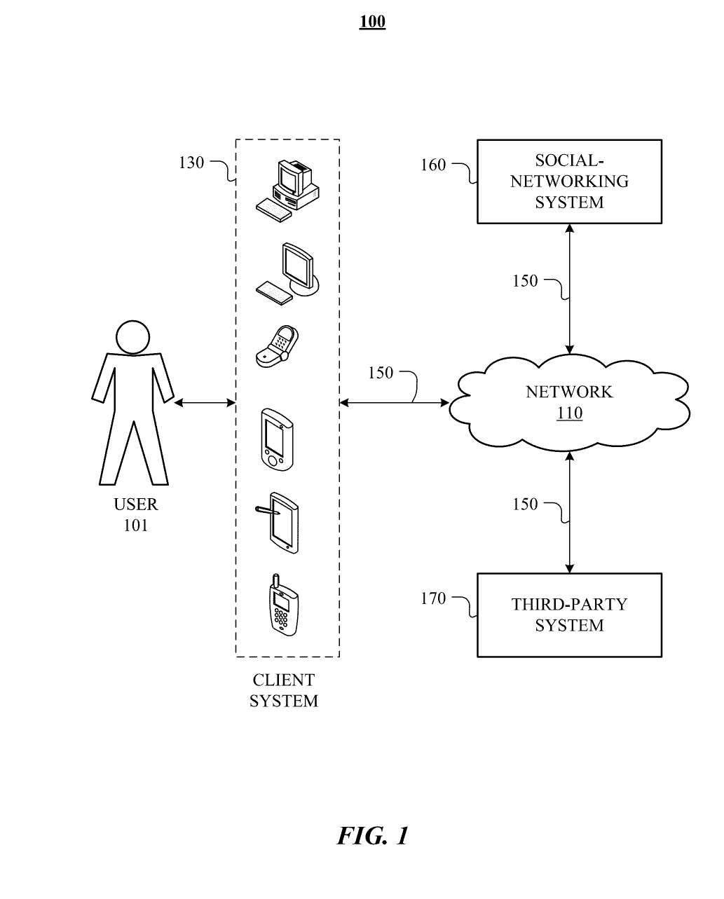

FIG. 1 illustrates an example network environment 100 associated with a social-networking system. Network environment 100 includes a user 101, a client system 130, a social-networking system 160, and a third-party system 170 connected to each other by a network 110. Although FIG. 1 illustrates a particular arrangement of user 101, client system 130, social-networking system 160, third-party system 170, and network 110, this disclosure contemplates any suitable arrangement of user 101, client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of users 101, client systems 130, social-networking systems 160, third-party systems 170, and networks 110, this disclosure contemplates any suitable number of users 101, client systems 130, social-networking systems 160, third-party systems 170, and networks 110. As an example and not by way of limitation, network environment 100 may include multiple users 101, client system 130, social-networking systems 160, third-party systems 170, and networks 110.

In particular embodiments, user 101 may be an individual (human user), an entity (e.g. an enterprise, business, or third-party application), or a group (e.g. of individuals or entities) that interacts or communicates with or over social-networking system 160. In particular embodiments, social-networking system 160 may be a network-addressable computing system hosting an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include an authorization server that allows users 101 to opt in or opt out of having their actions logged by social-networking system 160 or shared with other systems (e.g. third-party systems 170), such as, for example, by setting appropriate privacy settings.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, one or more users 101 may use one or more client systems 130 to access, send data to, and receive data from social-networking system 160 or third-party system 170. Client system 130 may access social-networking system 160 or third-party system 170 directly, via network 110, or via a third-party system. As an example and not by way of limitation, client system 130 may access third-party system 170 via social-networking system 160. Client system 130 may be any suitable computing device, such as, for example, a personal computer, a laptop computer, a cellular telephone, a smartphone, or a tablet computer.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

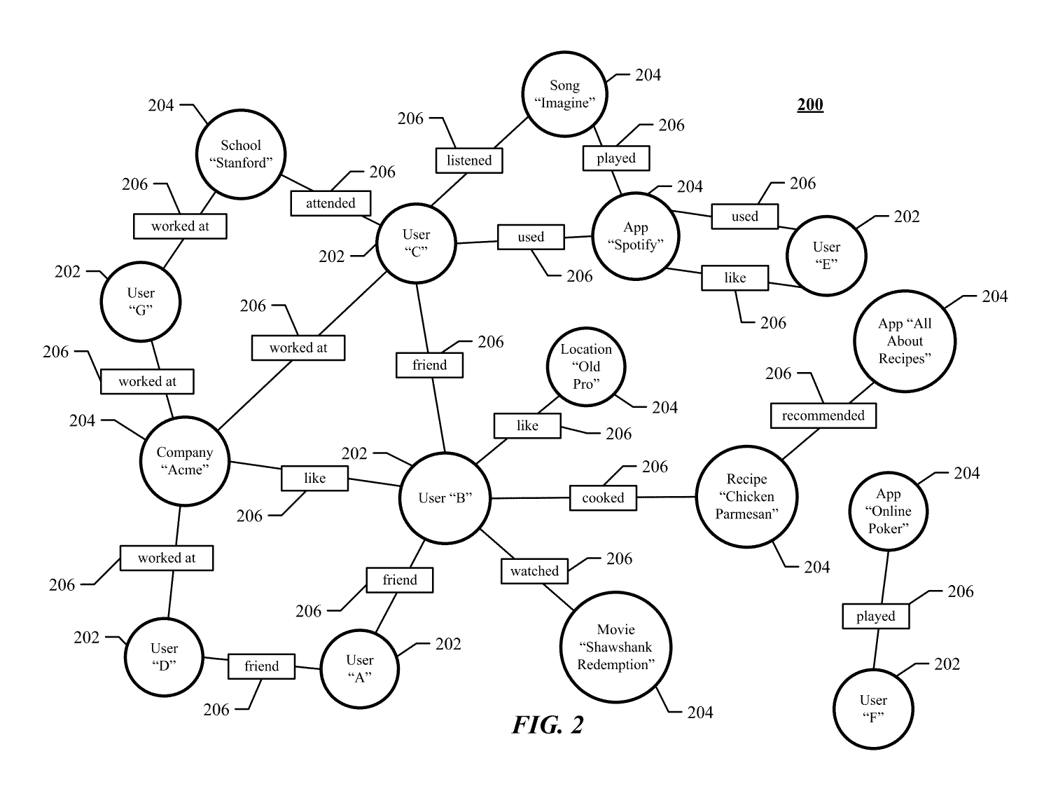

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g. an enterprise, business, or third-party application), or a group (e.g. of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g. an image of the cover page of a book); a location (e.g. an address or a geographical location); a website (which may be associated with a URL); contact information (e.g. a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g. “eat”), causing a client system 130 to send to social-networking system 160 a message indicating the user's action. In response to the message, social-networking system 160 may create an edge (e.g. an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 24. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, information from social-networking system 160 and/or social graph 200 may be explicit, stated information or explicit connections of a user to a node, object, entity, brand, or page on social-networking system 160. In addition or as an alternative, information from social-networking system 160 and/or social graph 200 may be inferred information (which may include analyzing a user's history, demographic, social or other activities, friends' social or other activities, subscriptions, or any of the preceding of other users similar to the user (based, e.g., on shared interests, connections, or events)).

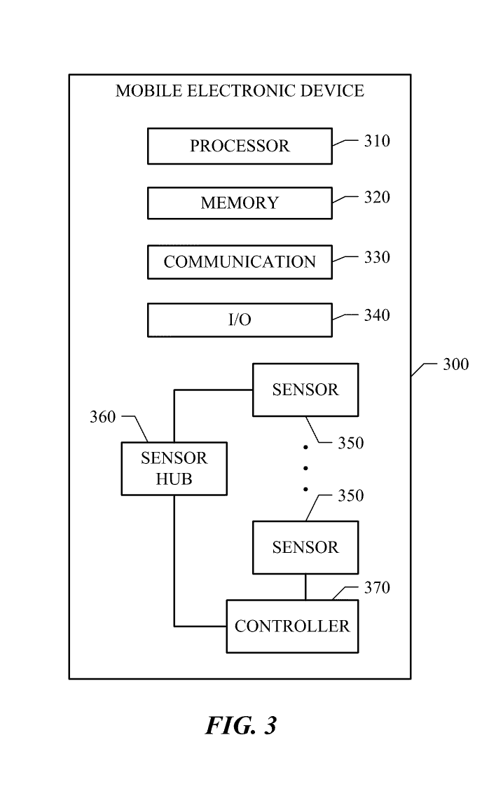

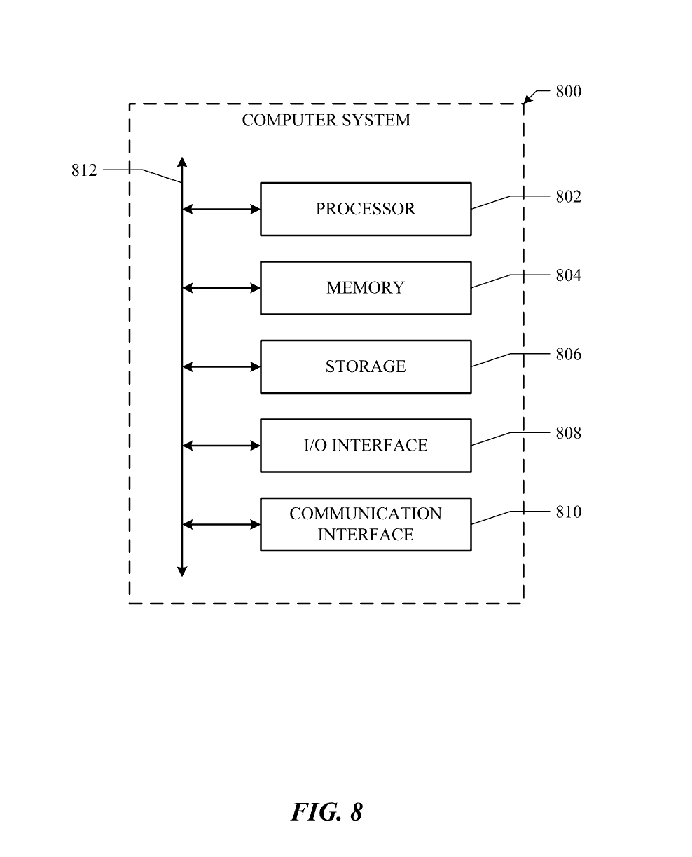

FIG. 3 illustrates an example personal computing device 300. In particular embodiments, personal computing device 300 may comprise a processor 310, a memory 320, a communication component 330 (e.g., antenna and communication interface for wireless communications), one or more input and/or output (I/O) components and/or interfaces 340, and one or more sensors 350. In particular embodiments, one or more I/O components and/or interfaces 340 may incorporate one or more sensors 350. In particular embodiments, personal computing device 300 may comprise a computer system or and element thereof as described in FIG. 8 and its associated description.

In particular embodiments, a personal computing device, such as a computing device, may include various types of sensors 350, such as, for example and without limitation: touch sensors (disposed, for example, on a display of the device, the back of the device and/or one or more lateral edges of the device) for detecting a user touching the surface of the mobile computing device (e.g., using one or more fingers); accelerometer for detecting whether the personal computing device 300 is moving and the speed of the movement; thermometer for measuring the temperature change near the personal computing device 300; proximity sensor for detecting the proximity of the personal computing device 300 to another object (e.g., a hand, desk, or other object); light sensor for measuring the ambient light around the personal computing device 300; imaging sensor (e.g., camera) for capturing digital still images and/or video of objects near the personal computing device 300 (e.g., scenes, people, bar codes, QR codes, etc.); location sensors (e.g., Global Positioning System (GPS)) for determining the location (e.g., in terms of latitude and longitude) of the mobile computing device; sensors for detecting communication networks within close proximity (e.g., near field communication (NFC), Bluetooth, RFID, infrared); chemical sensors; biometric sensors for biometrics-based (e.g., fingerprint, palm vein pattern, hand geometry, iris/retina, DNA, face, voice, olfactory, sweat) authentication of user of personal computing device 300; etc. This disclosure contemplates that a mobile computing device may include any applicable type of sensor. Sensors may provide various types of sensor data, which may be analyzed to determine the user's intention with respect to the mobile computing device at a given time.

In particular embodiments, a sensors hub 360 may optionally be included in personal computing device 300. Sensors 350 may be connected to sensors hub 360, which may be a low power-consuming processor that controls sensors 350, manages power for sensors 350, processes sensor inputs, aggregates sensor data, and performs certain sensor functions. In addition, in particular embodiments, some types of sensors 350 may be connected to a controller 370. In this case, sensors hub 360 may be connected to controller 370, which in turn is connected to sensor 350. Alternatively, in particular embodiments, there may be a sensor monitor in place of sensors hub 360 for managing sensors 350.

In particular embodiments, in addition to the front side, personal computing device 300 may have one or more sensors for performing biometric identification. Such sensors may be positioned on any surface of personal computing device 300. In example embodiments, as the user's hand touches personal computing device 300 to grab hold of it, the touch sensors may capture the user's fingerprints or palm vein pattern. In example embodiments, while a user is viewing the screen of personal computing device 300, a camera may capture an image of the user's face to perform facial recognition. In example embodiments, while a user is viewing the screen of personal computing device 300, an infrared scanner may scan the user's iris and/or retina. In example embodiments, while a user is in contact or close proximity with personal computing device 300, chemical and/or olfactory sensors may capture relevant data about a user. In particular embodiments, upon detecting that there is a change in state with respect to the identity of the user utilizing personal computing device 300, either by itself or in combination with other types of sensor indications, personal computing device 300 may determine that it is being shared.

In particular embodiments, in addition to the front side, the personal computing device 300 may have touch sensors on the left and right sides. Optionally, the personal computing device 300 may also have touch sensors on the back, top, or bottom side. Thus, as the user's hand touches personal computing device 300 to grab hold of it, the touch sensors may detect the user's fingers or palm touching personal computing device 300. In particular embodiments, upon detecting that there is a change in state with respect to a user touching personal computing device 300, either by itself or in combination with other types of sensor indications, personal computing device 300 may determine that it is being shared.

In particular embodiments, personal computing device 300 may have an accelerometer in addition to or instead of the touch sensors on the left and right sides. Sensor data provided by the accelerometer may also be used to estimate whether a new user has picked up personal computing device 300 from a resting position, e.g., on a table or desk, display shelf, or from someone's hand or from within someone's bag. When the user picks up personal computing device 300 and brings it in front of the user's face, there may be a relatively sudden increase in the movement speed of personal computing device 300. This change in the device's movement speed may be detected based on the sensor data supplied by the accelerometer. In particular embodiments, upon detecting that there is a significant increase in the speed of the device's movement, either by itself or in combination with other types of sensor indications, personal computing device 300 may determine that it is being shared.

In particular embodiments, personal computing device 300 may have a Gyrometer in addition or instead of the touch sensors on the left and right sides. A Gyrometer, also known as a gyroscope, is a device for measuring the orientation along one or more axis. In particular embodiments, a Gyrometer may be used to measure the orientation of personal computing device 300. When personal computing device 300 is stored on a shelf or in the user's bag, it may stay mostly in one orientation. However, when the user grabs hold of personal computing device 300 and lifts it up and/or moves it closer to bring it in front of the user's face, there may be a relatively sudden change in the orientation of personal computing device 300. The orientation of personal computing device 300 may be detected and measured by the Gyrometer. If the orientation of personal computing device 300 has changed significantly, In particular embodiments, upon detecting that there is a significant change in the orientation of personal computing device 300, either by itself or in combination with other types of sensor indications, personal computing device 300 may determine that it is being shared.

In particular embodiments, personal computing device 300 may have a light sensor. When personal computing device 300 is stored in a user's pocket or case, it is relatively dark around personal computing device 300. On the other hand, when the user brings personal computing device 300 out of his pocket, it may be relatively bright around personal computing device 300, especially during day time or in well-lit areas. The sensor data supplied by the light sensor may be analyzed to detect when a significant change in the ambient light level around personal computing device 300 occurs. In particular embodiments, upon detecting that there is a significant increase in the ambient light level around personal computing device 300, either by itself or in combination with other types of sensor indications, personal computing device 300 may determine that it is being shared.

In particular embodiments, personal computing device 300 may have a proximity sensor. The sensor data supplied by the proximity sensor may be analyzed to detect when personal computing device 300 is in close proximity to a specific object, such as the user's hand. For example, computing device 300 may have an infrared LED (light-emitting diode) 290 (i.e., proximity sensor) placed on its back side. When the user holds such a computing device in his hand, the palm of the user's hand may cover infrared LED 290. As a result, infrared LED 290 may detect when the user's hand is in close proximity to computing device 300. In particular embodiments, upon detecting that personal computing device 300 is in close proximity to the user's hand, either by itself or in combination with other types of sensor indications, personal computing device 300 may determine that it is being shared.

A personal computing device 300 may have any number of sensors of various types, and these sensors may supply different types of sensor data. Different combinations of the individual types of sensor data may be used together to detect and estimate a user's current intention with respect to personal computing device 300 (e.g., whether the user really means to take personal computing device 300 out of his pocket and use it). Sometimes, using multiple types of sensor data in combination may yield a more accurate, and thus better, estimation of the user's intention with respect to personal computing device 300 at a given time than only using a single type of sensor data. Nevertheless, it is possible to estimate the user's intention using a single type of sensor data (e.g., touch-sensor data).

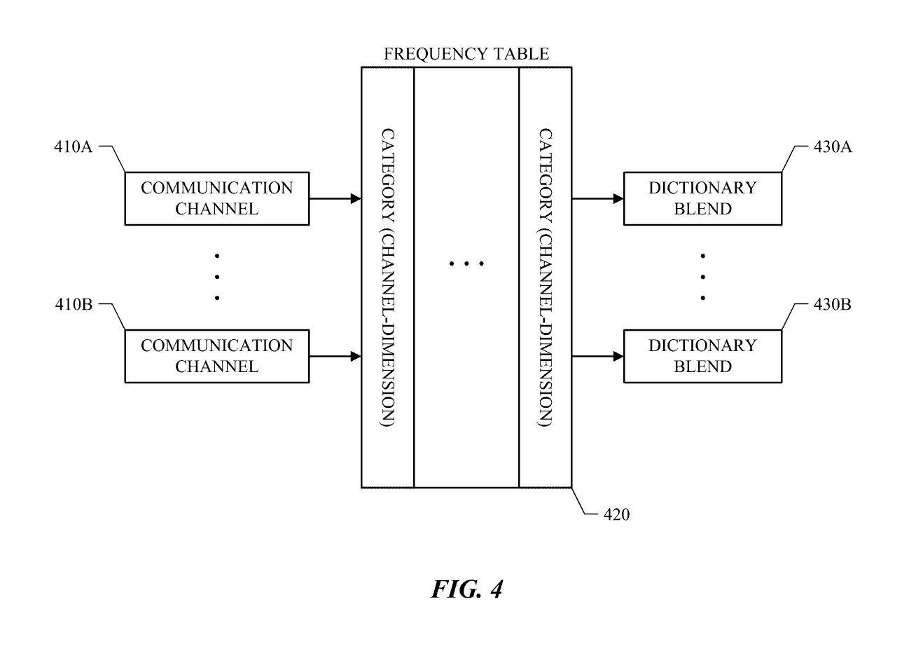

FIG. 4 illustrates an example system for creating customized dictionaries.

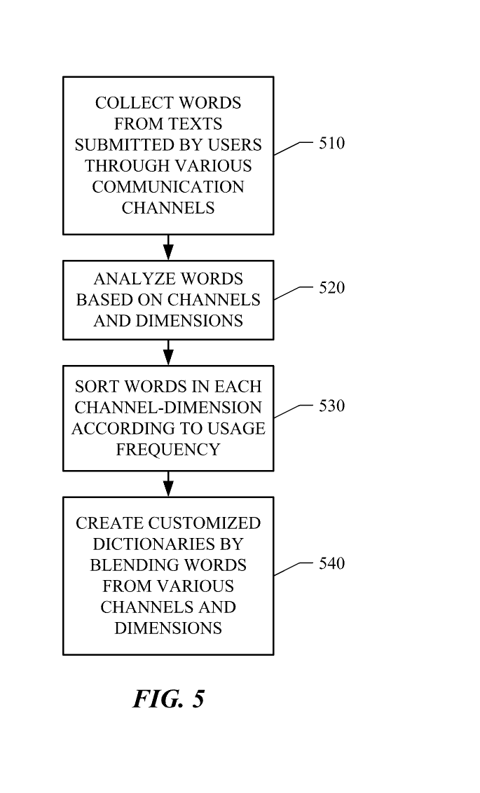

FIG. 5 illustrates an example method for creating customized dictionaries. These two figures are described in association with each other. As a user performs activities with his or her computing device, the user frequently submits texts (e.g., as input) through the computing device. The computing device, in this case, may be considered an input device, and may have any applicable form, such as, for example and without limitation, mobile device (e.g., mobile telephone, notebook or tablet computer, etc.), desktop computer, game console, and personal digital assistant (PDA). Similarly, the texts may have any applicable form and submitted for any applicable purpose, such as, for example and without limitation, e-mail, chat, post, comment, status update, tweet, and search query.

More generally, users may submit texts through any number of communication channels 410. In particular embodiments, each communication channel 410 may be characterized by any number of applicable features such as, for example and without limitation, the object being used for the communication, the input device used for submitting the texts (e.g., mobile device, non-mobile device, etc.), and the text input itself In particular embodiments, each communication channel 410 may be further characterized by any number of applicable dimensions such as, for example and without limitation, locale (e.g., the locale of the user submitting the texts), language (e.g., the language of the texts), geography (e.g., the location of the user when submitting the texts), culture (e.g., the cultural background of the user), the form or method of the communication (e.g., chat, message, comment, post, status update, etc.), and the intended recipient of the communication (e.g., communication to the general public or communication to specific individuals such as the user's friends and families).

Thus, given a specific text communication submitted by a specific user through a specific communication channel, the communication channel may indicate characteristics about the text such as the object used for the communication, the type of input device used by the user to submit the text (e.g., whether the input device is a mobile or non-mobile device, whether the input device has a full keyboard), the form or method of the communication, the language of the text, the locale, geography, or cultural background of the user, the recipient of the communication, and so on. In particular embodiments, words from texts submitted by various users through various communication channels 410 are collected, as illustrated in STEP 510. In some implementations, the input devices used by the users to submit texts may be online or offline. If an input device is online, the words may be collected from the text input as soon as the user submits them. If an input device is offline, the words may be collected subsequently (e.g., after the input device is connected to a network).

For each communication channel 410 from which texts are collected, the usage frequency of the individual words (i.e., how often a word is used in the texts) is analyzed along each dimension of each communication channel 410, as illustrated in STEP 520. For clarification purposes, each communication channel-dimension is referred to as a communication category.

As an example, suppose that the word “iPhone” has been found in the texts submitted by the users. The usage frequency of the word “iPhone” may be determined for each communication category (i.e., each unique channel-dimension). For example, in terms of communication form, the word “iPhone” may be used more frequently in chats than in e-mails or more frequently in comments than in tweets. In terms of user's geography location, the word “iPhone” may be used more frequently by users located in California than by users located in Montana. In terms of input device, the words “iPhone” may be used more frequently by users using mobile telephones than by users using desktop computers. In terms of user's cultural background, the words “iPhone” may be used more frequently by younger users (e.g., ages 16 to 35) than by older users (e.g., ages 60 and older).

As another example, with modern electronic communication, shorthand or word abbreviation is favored especially by mobile device (e.g., mobile telephone) users. Suppose that the word “lol” (abbreviation for “laughing out loud”) has been found in the texts submitted by the users. Again, the usage frequency of the word “lol” may be determined for each communication category. For example, in terms of language, the word “lol” may be used more frequently by English-speaking users than by non-English-speaking users. In terms of input device, the words “lol” may be used more frequently when the texts are submitted through mobile telephones.

In particular embodiments, for each word collected, the stem of the word is considered. For example, for “wait”, “waits”, “waited”, and “waiting”, the stem is “wait”. For “relate”, “related”, “relationship”, and “relating”, the stem is “relate”. In some implementations, when determining the usage frequency of a word, those words sharing the same stem may be considered the same word.

In particular embodiments, certain undesirable words may be filtered out and discarded. For example, swearing words in various languages, words or abbreviations that are offensive, words or abbreviations that may make people uncomfortable, or misspelled words may be discarded. In particular embodiments, certain desirable words may be added. For example, popular website names (e.g., Facebook, Google, Yahoo, Amazon, Flickr, Twitter) or product names (e.g., iPad, iPhone, Xbox, Play Station) or trendy terms or abbreviations (e.g., omg, LQTM) may be added.

In particular embodiments, for each communication category, the words are sorted according to their respective usage frequencies in that communication category, as illustrated in STEP 530. In some implementations, a frequency table 420 may be constructed, which may include any number of applicable communication categories (e.g., determined based on communication channels and dimensions). For each communication category, the usage frequencies of the words collected from the texts submitted by the users may be stored in frequency table 420.

In particular embodiments, customized dictionaries 430 may be created by blending the words from some or all of the communication categories, as illustrated in STEP 540. In some implementations, only the more frequently used words from each communication category are used to create the customized dictionaries. For example, the top n (e.g., n=25,000) most frequently used words from each communication category are blended.

In particular embodiments, different customized dictionaries may be created by blending the words from various communication categories differently. A customized dictionary may be created for each individual user or group of users (in which case the same customized dictionary is used for every user in the group). Similarly, a customized dictionary may be created for each communication channel, each type of input device, each form of communication, and so on. For example, a customized dictionary may be created for comments, while another customized dictionary may be created for chats or instant messages. A customized dictionary may be created for use with mobile input devices, while another customized dictionary may be created for use with non-mobile devices. Different customized dictionaries may be created for users from different countries and thus speaking different language, or for users in different age groups, or for users in different professions, and so on. Different customized dictionaries may be created for different individual users as well. In addition, a specific user may have multiple customized dictionaries for use under different circumstances (e.g., different input devices, communication forms, and recipients).

In some implementations, coefficients may be used to determine the blending of the most frequently used words from various communication categories in order to construct a customized dictionary for a specific user or group of users. In particular embodiments, there may be any number of entities, also referred to as users, in existence. In this context, the term “user” is not limited to humans, but may include any type of entities, human or non-human (e.g., objects), real or virtual (e.g., web pages, digital files). In particular embodiments, the entities or users may exist anywhere. Individual users may interact with each other via the Internet. For example, a human may comment on a photo, post a message, share content with other humans, chat with another human, subscribe to a news group. Two humans may live in the same city, go to the same school, work at the same place, are members of the same family. Two messages may belong to the same thread. Two photos may belong to the same album or be submitted by the same human. The specific cases vary greatly. In particular embodiments, if there is any type of connection or association between two users, then the two users are considered to have interacted with each other.

In particular embodiments, the interactions between the individual users are monitored and collected for specific periods of time (e.g., during the past X number of days, such as the past 30, 60, or 90 days). In some implementations, the users and their interactions may be represented using a graph, which may include any number of nodes and edges. Each node represents a user (e.g., human or object). If there is an interaction between two users, then an edge connects the two corresponding nodes respectively representing the two users. In addition, for each edge, there may be associated data indicating how strong the interaction is between the two users represented by the nodes linked by the edge. Given two users, the information stored in the graph may be used to determine the affinity between the two users based on each user's historical activity. In some implementations, the affinity between two users may be computed using an affine function that include a number of coefficients. In some implementations, some or all of these coefficients may be determined through machine learning. More specifically, in some implementations, a supervised machine learning algorithm may be used with the training data obtained through farming, by providing a statistically significant number of users several options and monitoring their response. In other implementations, a supervised machine learning algorithm is trained entirely based on historical user activity and past responses to choices of actions.

In particular embodiments, coefficients may be similarly (e.g., through machine learning) determined in connection with words used by humans when inputting texts in various communication channels. In some implementations, a coefficient is associated with and determined for each communication category. Alternatively or in addition, in some implementations, a coefficient is associated with and determined for each word used to create the customized dictionaries. The blending of the most frequently used words from various communication categories may be adjusted by adjusting the coefficient values associated with the individual communication categories or the words in each communication category. In some implementations, when blending the words to create a customized dictionary for a user or a group of users, the coefficients of the communication category or words may be adjusted based on factors such as, for example and without limitations, the type of input devices, the language of the texts, the location and background of the users, and the form of communication for which the customized dictionaries are to be used. As an example, if a customized dictionary is created for use with mobile devices, it may include more shorthand or abbreviations. In addition, since communications sent through mobile device are often less formal, the customized dictionary for mobile devices may not include words such as “the”, “a”, etc. If a customized dictionary is created for teenage users, it may include more trendy or fashionable terms. If a customized dictionaries is created for a group of engineers, it may include more scientific or technical terms.

In particular embodiments, customized dictionaries may be created for users who are members of a social-networking website (e.g., www.facebook.com). Each user may have his or her personal social connections (e.g., friends and families, co-workers) with the social-networking website. A customized dictionary may be created for each individual user, and may include the names of that user's social connections. In fact, customized dictionaries may be created at any level of granularity. For example, given a specific user, one customized dictionary may be created for this user for use with his mobile telephone to send instant messages to his personal friends and families, while another customized dictionary may be created for this user for use with his desktop computer to send e-mails to his colleagues and professional associates. A third customized dictionary may be created for this user specifically for use in communication with his father. The coefficients associated with the words may be adjusted based on the social information of the users maintained with the social-networking website. Such social information may include, for example and without limitation, the social connections among the users (e.g., the degree of separation between two users) and the actions taken by the users (e.g., posting messages, checking in status, uploading and sharing videos and photos, reviewing products, commenting on various topics).

Languages are fluid and evolve over time. New words are created or migrate from one language to another. Existing words may pick up new meanings or are used in new ways. On the other hand, some words may fall out of common usage as time passes. In particular embodiments, words are continuously collected from texts submitted by the users through various communication channels, and their usage frequencies in each communication category are updated from time to time. Within each communication category, as the words are sorted according to their respective usage frequencies, those words that are more popular among the users move up in rank while those words that are less frequently used move down in rank. By selecting the top n most frequently used words from each communication category for blending to create the customized dictionaries, the resulting dictionaries include those words frequently used by the users at any given time. In particular embodiments, the customized dictionaries may be updated from time to time to reflect any change in word usage or the current state of word usage among the users. Consequently, the customized dictionaries are dynamic and do not suffer those limitations associated with traditional or standard dictionaries. For example, words such as “computer”, “multi-media”, “Internet”, “blog” are commonly used by users from different parts of the world who speak different languages. Thus, their usage frequencies may be high even among texts submitted by non-English-speaking users. When creating a customized dictionary for German-speaking users, it may include these English words as well. As a result, a customized dictionary may include words from multiple languages. As another example, with mobile device users, new trendy words may appear and quickly gain popularity among the users. As a new word becomes more and more popular among the users, its usage frequency increases accordingly. The word may be included in the customized dictionaries as it becomes sufficiently popular among the users, even though it does not exist in traditional dictionaries.

In particular embodiments, when a customized dictionary is created or updated, it may be sent to the user or users (e.g., pushed to the user's device) for whom the customized dictionary is created. Software functions that rely on a dictionary may use this customized dictionary instead of the standard dictionary.

As described above, in particular embodiments, any number of customized dictionaries may be constructed for a user. Different customized dictionaries may be suitable for different types of input devices, different communication channels, different forms of communications, different recipients, and so on. In addition, in particular embodiments, the words included in the customized dictionaries constructed for a specific user may be selected based in part on the information known about the user, such as the user's demographical information (e.g., age, gender, professions, education, location, hobbies and interests, etc.), the user's social connections (e.g., the names of the user's friends, families, colleagues, etc.), locations the user likes to visit (e.g., the names of the bars or restaurants the user prefers), the activities the user likes to do, etc. For example, if the user is from or lives on the East Coast of the United States, the customized dictionaries may include more words commonly used by people from the East Coast. If the user is from or lives in one of the Southern states of the United States, the customized dictionaries may include more words commonly used by the people from the South. As another example, if, among the user's social connections at a social-networking website, the following people are known to be close social connections of the user: Paula Smith, Andrew Jones, Mary Jackson, and Henry Brown. A customized dictionary constructed for this user (e.g., especially one for use when the user sends messages to his or her friends) may include those specific names of the user's close social connections (e.g., Paula, Andrew, Mary, and Henry), even if those names are not among the most frequently used words found in the texts submitted by the users in general. As a third example, if the user is fluent in multiple languages and uses words from multiple languages in his or her speech, a customized dictionary may include words from several languages used by the user.

In particular embodiments, if there is little or no information known about a user, a default customized dictionary may initially be utilized for the user. In some implementations, the default customized dictionary may be an average blending of the most frequently used words from various communication categories. Thereafter, as more information becomes known about the user (e.g., the names of the user's social connections, the user's hobbies and interests, the user's speech pattern, etc.), the customized dictionary may be updated from time to time to reflect the new information known about the user (e.g., adding the names of the user's social connections or the words the user likes to use in his or her speech to the customized dictionary).

In particular embodiments, multiple customized dictionaries may be constructed for a user. When customized dictionaries are constructed for a user, the same customized dictionaries may be utilized in connection with any software operation provided by any software application performed on any computing device. Consequently, the user does not need to deal with multiple versions of dictionaries, but may have a consistent experience in terms of inputting texts for various purposes.

In some embodiments, each customized dictionary may be a different blending of the most frequently used words from various communication categories (as described above), and may be suitable for use with different software operations or on different types of devices. These dictionaries are constructed for the user, taking into consideration factors such as the user's preferences, interests, demographic information, social connections, etc. Thus, the customized dictionaries include words more suitable to the user's needs than, for example, a standard dictionary.

For example, a customized dictionary created for a user may include words especially applicable to the user's circumstances, such as the names of the user's friends and families or words commonly used in the user's professional field. Such a customized dictionary may replace the standard dictionaries provided by various software applications. Consequently, when the user uses any software application on any device, the same customized dictionary is used and those words especially applicable to the user's circumstances are always available to the user.

In particular embodiments, if a user is a member of a social-networking system, copies of the customized dictionaries constructed for the user may be stored with the social-networking system for the user. When the user performs any activity that may need a dictionary, the social-networking system may provide a suitable customized dictionary to the device used by the user.

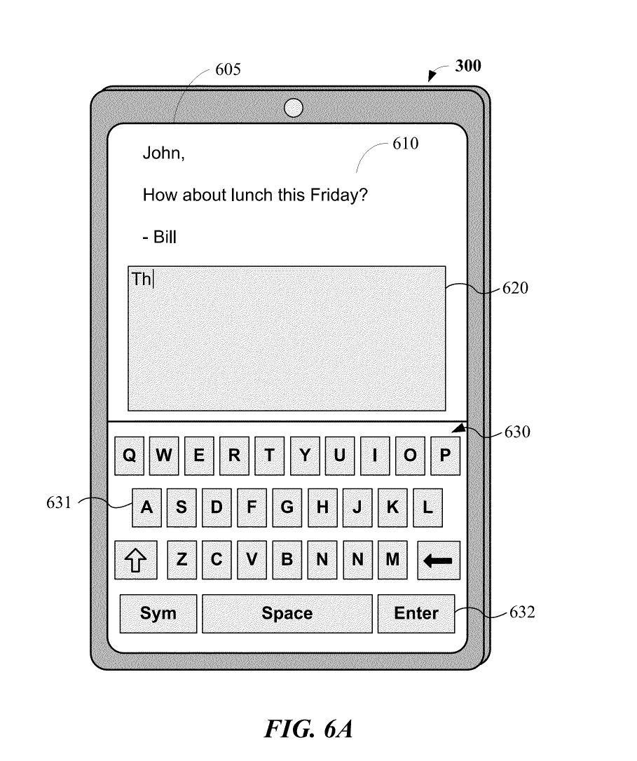

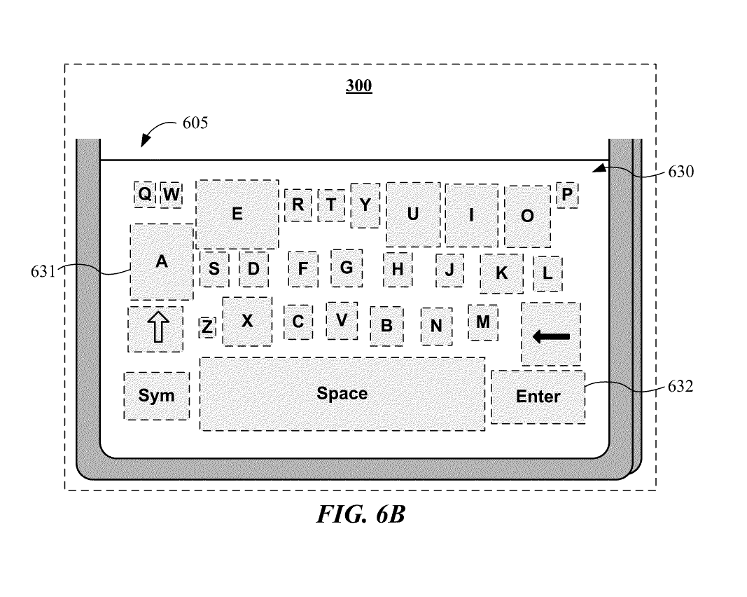

FIG. 6A illustrates an example scenario in which a user provides input to the personal computing device of FIG. 3. In particular embodiments, personal computing device 300 includes a touch screen 605. In some embodiments, user may wish to use personal computing device 300 to communicate with one or more additional users (e.g., such as friends and/or family of the user). In order to do so, a user can tap on the screen (or input another appropriate indication) to unlock the device, browse to a webpage (or any other application that allows a communication session to occur), and open up an interface for communication.

In particular embodiments, some inputs to personal computing device 300 can be performed by tapping or pressing on a certain region of the screen 605. For example, a user can select a message received from another user by tapping on message 610. By tapping on message 610, field 620 may be displayed on screen 605, allowing the user to communicate with the other user by inputting data into field 620. As shown, to permit a user to input data into a field, for example, when a field is selected, the personal computing device 300 can display a virtual keyboard 630 on the touch screen 605. The user can input data by typing on the symbols of the virtual keyboard 630 to input corresponding letters, numbers, symbols, etc. For example, to input a letter “A” into a field, the user can tap the region of the touch screen 605 marked as a box marked with a letter “A” (i.e., the “A” key 631). Similarly, to input a line break or the completion of an entry, the user can tap the “Enter” key 632, marked as a box with the word “Enter.”

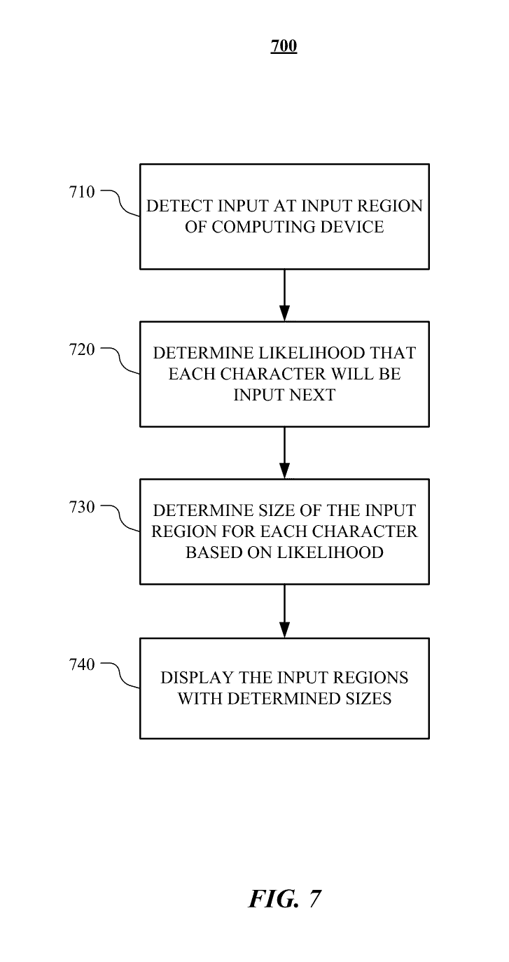

A user can perform errors while inputting data using the touch screen 605. For example, while intending to touch the region of the “A” key 631, a user instead can inadvertently touch an adjacent region of the touch screen 605, including a region associated with another letter. This can cause the user to notice the error and correct the input error, or can cause the personal computing device 300 to suggest a correction for a misspelled word. However, according to one aspect of the present disclosure, a personal computing device 300 can adapt the virtual keyboard 450 based on the user's likelihood to touch certain keys. For example, as shown in FIG. 6B, the personal computing device 300 may adjust the size of the “A” key 631 (among others) to account for the fact that the user likely meant to hit the “A” key 631 rather than the region adjacent to it, as discussed in further detail below with reference to the diagram of FIG. 7.

FIG. 7 illustrates an example method 700 for adapting characteristics of the input region (e.g., the virtual keyboard) of the personal computing device of FIG. 3. The method may begin at step 710, where input is detected at the input region of the personal computing device. This may include detecting a tap, swipe, or any other suitable gesture on a touch screen that may indicate to the computing device that the user intends to enter text or other characters. Once detected, the computing device may provide a plurality of subregions, which may include keys of a virtual keyboard. Detecting input may also include detecting key presses on a virtual keyboard already displayed on a touch screen of the computing device. Detecting input may further include detecting a string of characters forming an input sequence. In some embodiments, each sequence may be separated from the other based on punctuation or white space entered by the user.

At step 720, a likelihood is determined for each character based on how likely that particular character will be input next by a user. This may include, for example, determining a probability for each potential input character based on a user dictionary. The potential input characters may be stored on the personal computing device, and may include characters from one or more languages. In some embodiments, the user dictionary may be stored locally on the computing device and may include a list of commonly used words. In other embodiments, the user dictionary may be stored on a remote server. In particular embodiments, the user dictionary may be custom to the user based on the user's previous input tendencies and/or patterns. For example, the user dictionary may be constructed according to the system and method of FIGS. 4-5, respectively. Each user may have one or more custom user dictionaries based on the context of the input being entered. For example, the user dictionary used in entering text into an email application may be different from that which would be used for entering text into an SMS application. For example, the dictionary used for SMS messages may used words that are less formal than those in the dictionary used for email messages. Similarly, the user dictionary used in entering text in a message to a family member (e.g., less formal words and/or phrases) may be different from that used in entering text in a message to a co-worker (e.g., more formal words and/or phrases). Further the user dictionary used in entering text to a message intended for a group may be different from that used in entering text to a massage intended for an individual. In some embodiments, the language of the dictionary may change based on the context of the communication. For instance, a bilingual user may use a primarily English-based dictionary when communicating with co-workers, but may use a primarily Spanish-based dictionary when communicating with family members.

At step 730, a size is determined for each input region based on the likelihood determined for each character in step 720. In some embodiments, some constraints may be placed on the size that each character may be re-sized to. For example, consider a character with close to a 100% likelihood of being input next. It may not be desirable for the key associated with the character to take up close to 100% on the virtual keyboard being displayed. Similarly, a key associated with a character having zero or close to zero likelihood of being next should not necessarily disappear from the virtual keyboard. Thus, in certain embodiments, the size determined for each character may be based on some other constraint such as a minimum and/or maximum size that it may be. In addition, in some embodiments, the determined size of each input region may be based on the relative probabilities between all other input regions. For example, the new size of a key may be determined based on how much larger and/or smaller other keys (e.g., adjacent keys) will be.

Finally, at step 740, the input regions are displayed according to the determined sizes. This may include, for example, modifying the size of one or more keys of a virtual keyboard displayed on the computing device, as shown in FIGS. 6A-6B above, based on the determined likelihood that the associated character will be input next by the user. In particular embodiments, one or more keys on a virtual keyboard may be associated with more than one character. In such embodiments, the character displayed in the input region may be the one that is more likely to be input next. For example, certain keys on a virtual keyboard may also be associated with numbers (e.g. after hitting a “sym” key as shown in FIGS. 6A-6B). In many cases, the user will be more likely to input a letter; however, in some instances, the user may be more likely to input a number (e.g. when entering a password). In such cases, the number may be displayed on the virtual keyboard without requiring the user to hit the “sym” key first.

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by a computing device, detecting that a first user is entering a text input at an input region of the computing device, the input region comprising a plurality of subregions, each subregion associated with at least one character of a plurality of characters;
by the computing device, determining, for each character of the plurality of characters as the first user enters the text input, a probability that the character is next in the text input; and
by the computing device, determining a size of each subregion based on the determined probability of the character associated with the subregion.

2. The method of claim 1, wherein the determined probability is based on one or more customized dictionaries associated with the first user.

3. The method of claim 2, wherein the one or more customized dictionaries are based on input histories associated with the first user.

4. The method of claim 2, wherein the one or more customized dictionaries are based on a usage context comprising: an application on the computing device receiving the input term, a second user with whom the first user is communicating, or any combination thereof.

5. The method of claim 1, wherein at least one subregion is associated with a plurality of characters, and wherein the character displayed in the at least one subregion associated with a plurality of characters is based on the determined probabilities of each character associated with the at least one subregion.

6. The method of claim 1, wherein the input region comprises at least one of a touch-sensitive screen, a touch sensor, a virtual keyboard, an optical sensor, a motion sensor, or any combination thereof.

7. The method of claim 6, further comprising, by the computing device, displaying the subregions at the input region based on the determined size.

8. One or more computer-readable non-transitory storage media embodying software that is operable when executed to:
detect that a first user is entering a text input at an input region of the computing device, the input region comprising a plurality of subregions, each subregion associated with at least one character of a plurality of characters;
determine, for each character of the plurality of characters as the first user enters the text input, a probability that the character is next in the text input; and
determine a size of each subregion based on the determined probability of the character associated with the subregion.

9. The media of claim 8, wherein the determined probability is based on one or more customized dictionaries associated with the first user.

10. The media of claim 9, wherein the one or more customized dictionaries are based on input histories associated with the first user.

11. The media of claim 9, wherein the one or more customized dictionaries are based on a usage context comprising: an application on the computing device receiving the input term, a second user with whom the first user is communicating, or any combination thereof.

12. The media of claim 8, wherein at least one subregion is associated with a plurality of characters, and wherein the character displayed in the at least one subregion associated with a plurality of characters is based on the determined probabilities of each character associated with the at least one subregion.

13. The media of claim 8, wherein the input region comprises at least one of a touch-sensitive screen, a touch sensor, a virtual keyboard, an optical sensor, a motion sensor, or any combination thereof.

14. The media of claim 8, wherein the software is further operable when executed to display the subregions at the input region based on the determined size.

15. A system comprising:
one or more processors; and
a memory coupled to the processors comprising instructions executable by the processors, the processors being operable when executing the instructions to:
detect that a first user is entering a text input at an input region of the computing device, the input region comprising a plurality of subregions, each subregion associated with at least one character of a plurality of characters;
determine, for each character of the plurality of characters as the first user enters the text input, a probability that the character is next in the text input; and
determine a size of each subregion based on the determined probability of the character associated with the subregion.

16. The system of claim 15, wherein the determined probability is based on one or more customized dictionaries associated with the first user.

17. The system of claim 16, wherein the one or more customized dictionaries are based on input histories associated with the first user.

18. The system of claim 16, wherein the one or more customized dictionaries are based on a usage context comprising: an application on the computing device receiving the input term, a second user with whom the first user is communicating, or any combination thereof

19. The system of claim 16, wherein at least one subregion is associated with a plurality of characters, and wherein the character displayed in the at least one subregion associated with a plurality of characters is based on the determined probabilities of each character associated with the at least one subregion.

20. The system of claim 15, wherein the input region comprises at least one of a touch-sensitive screen, a touch sensor, a virtual keyboard, an optical sensor, a motion sensor, or any combination thereof.
